(19) United States
(12) Patent Application Publication
(10) Pub. No.: US 2016/0096190 A1
(43) Pub. Date: Apr. 7, 2016

(54) Apparatus to produce 3D curved flocked articles

(71) Applicant: TamiCare Ltd., Heywood (GB)

(72) Inventor: Ehud GILOH, Heywood (GB)

(21) Appl. No.: 14/870,528

(22) Filed: Sep. 30, 2015

Related U.S. Application Data
(60) Provisional application No. 62/058,192, filed on Oct. 1, 2014.

(51) Int. Cl. B05C 19/00

(52) U.S. Cl. CPC B05C 19/008; B05C 19/001

(57) ABSTRACT

An apparatus for flocking a curved article is disclosed. The apparatus includes a flocking machine having a curved mesh with a plurality of sectors, the curved mesh being constructed to conform to the curve of a curved object to be flocked. The curved object also includes a plurality of sectors, and is placed at a distance from the curved mesh such that a constant gap is provided between each sector on the curved object and the corresponding sector of the curved mesh.

### CROSS REFERENCE TO RELATED APPLICATIONS

This application claims priority to U.S. Provisional Application Ser. No. 62/058,192, filed Oct. 1, 2014, the entire contents of which are incorporated herein by reference for all purposes.

### BACKGROUND

Production of 3D curved flocked articles in an industrial process introduces a major challenge in overcoming the shortcomings of the current flocking technology, mainly due to limitations of the flocking machines structure and technique.

A common flocking machine comprises a container equipped with a mesh, the mesh facing the object to be flocked, which is usually below the mesh. A brush or another means for discharging fibres via the mesh is also provided. The process comprises a step of presenting static or moving object/s below the mesh, for the flocking session.

The existing technologies and equipment suffer drawbacks related to uniformity and quality of coverage, as well as limitations related to the speed of flocking process. Moreover, the existing technology does not allow sufficient flock coating uniformity of curved objects when the process is carried out in mass production system or when the products to be flocked are moving on a conveyor belt in an industrial manufacturing line.

It is also difficult to create uniform flock coverage on curved objects, even when an electrostatic flocking is engaged, as the electrostatically charged fibres are attracted to the nearest points of the convex object/s to be flocked. Additionally, the ‘Faraday cage’ effect makes it hard to flock concave objects. Therefore, pneumatic flocking equipment which employs a stream of pressurized air to blow the fibres into the concaved area is usually used.

The pneumatic system may require moving the pneumatic flocking application head along the flocked curved object. The need for moving the flocking machine above the object makes the process very slow and complicated, yet not necessarily providing the desired uniformity.

Therefore it is desired to provide a simple and reliable flocking system for 3D curved surfaces, particularly when the flocking process is employed in mass production manufacturing lines, where repeatability and consistency are crucial.

### SUMMARY OF THE INVENTION

An apparatus is provided for producing a uniformed flocked coating on 3D or curved surfaces or objects is disclosed herein. The system relates to a production process wherein a liquid or any other suitable sprayable material may be applied on a curved surface, such as curved or 3D mold, curved or 3D mold mounted on a conveyor belt, curved conveyor belt or any other curved object.

Such a conveyor belt or system may be mounted adjacent to the flocking unit, as an example, or can be mounted below the flocking unit at such distance so that a gap suitable for performing the flocking process is provided, as known to a skilled person in the flocking art.

Alternatively, the object may be a semi-finished product, brought to the process from different production system, requires an additional production step of flock coating.

The invention introduces a unique flocking system which features a 3D curved design of the mesh component of the flocking unit, where the 3D curved design complements or correlates with the object to be flocked, so that every sector on the curved object (to be covered with flocked fibers) is situated at an approximately similar distance from a conforming sector on the flocking machine mesh.

An apparatus configured for carrying out the improved flocking method is also disclosed herein. The apparatus may be a part of a production line, a part of a small scale non-industrial apparatus or a part of any other production apparatus that can produce flocked products. The disclosed apparatus may be used also as a stand-alone apparatus.

The apparatus comprises a flocking device equipped with a curved mesh, wherein the shape of the curved mesh substantially complements or conforms to the shape of the curved object or surface to be flocked, while maintaining a constant, uniform gap (distance) between the object to be flocked and the flocking apparatus curved mesh, so that every given point or zone on the curved object to be flocked is situated at an approximately similar distance from the corresponding point on the flocking apparatus curved mesh. The distance is measured perpendicular to the given point on the surface of the object to be flocked. The curved mesh can be pre-made by any suitable means to match the specific shape of the object to be flocked. For instance, a single piece of steel mesh can be bent into a curve using a conventional bending machine. The curved mesh provides even and uniform flocking, as the fibers along the entire outline of the flocking apparatus mesh are applied from an equal distance, so that fibers speed and distribution is uniform and even, this applies to any flocking technique, electrostatic, non-electrostatic, pneumatic, or any other flocking method.

### DESCRIPTION OF THE DRAWINGS

FIG. 1 illustrates one embodiment of a flocking machine for flocking a curved object of the present application.

FIG. 2 illustrates another embodiment of a flocking machine for flocking a curved object of the present application including a brush.

FIG. 3 illustrates a carousel based flocking machine with a number of curved mesh components and a corresponding conveyor belt.

### DETAILED DESCRIPTION OF THE INVENTION

In this application, the terms “object”, “mould” (mold), “former”, “workpiece” and “surface” are interchangeable.

In this application, the term “flocking” refers to coating a surface with loose fibers, such as but not limited to: cotton, viscose, polyamide, polyester, wool, silk, metal, plastic, glass, rubber, SAF, any other suitable fibers. Usually such fibers are approximately 0.2 to 20 mm long.

An example process for producing a 3D curved flocked article may comprise the following steps: (a) providing a curved object; (b) applying a material to the curved object; the material may be wet or sticky. As an example, the material can be sprayed or brushed. (c) flocking the curved object using a flocking machine (100), comprising a curved mesh (101); the curved mesh (101) outline conforming to the outline of the curved object (10) or surface to be flocked, while maintaining a constant gap (102) between the object to be flocked and the flocking apparatus curved mesh (101), so that every given point or zone of the curved object (10) or surface to be flocked, is situated at an approximately similar distance from the corresponding point on the flocking apparatus curved mesh (101). The curved object 10 is placed and held at a distance from the curved mesh 101 to create the gap 102.

The curved object may be, or may consist of, without limitation, a curved conveyor system, a series of curved objects or series of curved objects placed on a moving conveyor system, a finished product/s, a semi-finished product/s or product/s in process. The curved object/s can include convex or concave areas and can be used for manufacturing of any desired product/s such as but not limited to garments, lingerie, panties, bras, shoes, medical bandages and dressing, decorations, clothing, carpets, pads, boxes or any other curved objects.

In at least one step of material application, the material application may include applying any suitable material such as liquid or other sprayable material on at least a part of the object. Such materials may include, but is not limited to gels, natural, artificial or synthetic polymer in the form of a liquid, solution or suspension, foam, release agent, hot melt, adhesive or powder, such material can be applied by any suitable application device, such as but not limited to: spray gun, electrostatic spray gun, brush, pad, or any other suitable device.

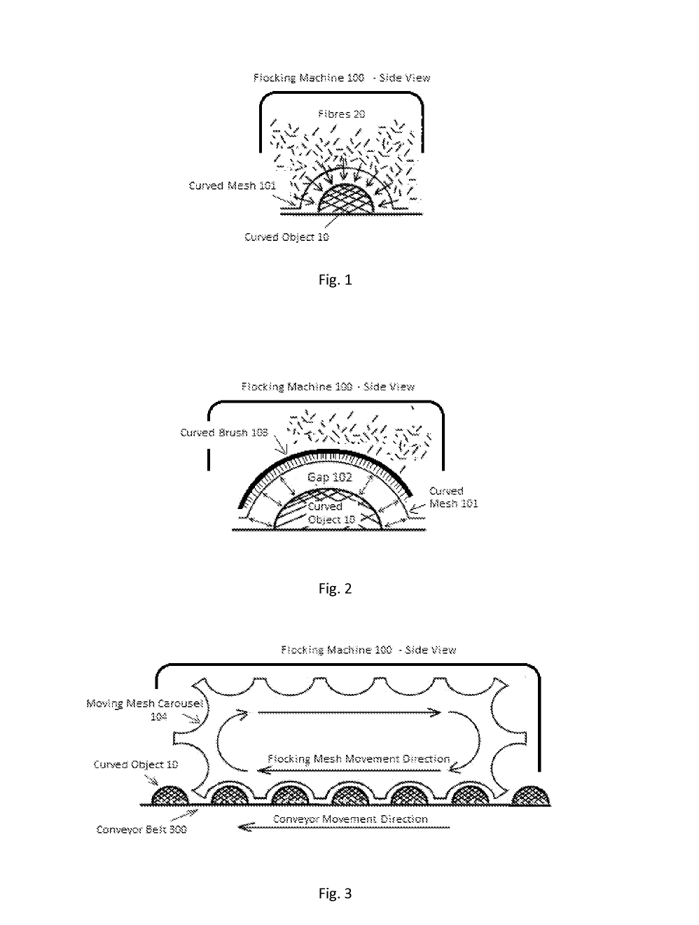

As shown in FIG. 1, the step of flocking includes the use of a flocking machine (100), comprising a curved mesh (101) having a plurality of sectors or zones, the curved (101) mesh outline being constructed to substantially conform to the shape or outline of the curved object (10) or surface to be flocked. The curved object includes a plurality of sectors or zones, and each sector has a constant gap (102) between the object to be flocked and the flocking apparatus curved mesh (101), so that every given sector, point or zone of the curved object (10) or surface to be flocked is situated at a substantially similar distance from the corresponding point on the flocking apparatus curved mesh (101).

In one embodiment, the flocking machine comprises a curved brush, (103) which conforms to the shape of the mesh (101). The curved brush is positioned adjacent to the mesh, the brush can move, vibrate, or rotate, by any suitable moving device, such as but not limited to: a motor, a pneumatic piston, eccentric turbine, or any other suitable device, on top of the mesh, so that the flocked fibers (20) are pushed by the brush movement, and therefore transferred through the mesh (101).

In another embodiment, the mesh (101) itself rotates or vibrates, causing the fibres (20) to move through said mesh. The mesh can be moved or driven by any suitable moving device, such as but not limited to: a motor, a pneumatic piston, eccentric turbine, or any other suitable device. The moving device may be connected to the mesh by any suitable means, such as by a shaft and screw, for example.

In yet another embodiment, the mesh moves next to or above the series of objects, in same speed of the objects, maintaining a uniform, even gap between the mesh and the objects.

The core of this invention is the flocking machine curved mesh which conforms to the shape of the curved object/s (to be coated with flocked fibers) and follow its outline/s, keeping a uniform, even, gap or distance from the object to be flocked outline and the mesh outline. Any mesh arrangement, configuration or embodiment may be used in the machine of the present application, such as but not limited to a closed loop curved mesh carousel (104), a plurality of moving curved meshes or any other suitable arrangement. The moving carousel 104 may comprise a plurality of curved meshes.

In yet another embodiment, a pneumatic flocking system, or pneumatic assisted flocking system utilizing pressurized air or gas can be used to assist or perform pushing the fibers through the mesh (101). Pressurized air can be provided by any suitable means, such as but not limited to: a compressor, a turbine, fan or by any other suitable device, as known in the flocking art.

Representative examples of curved articles to be manufactured using the disclosed apparatus include, without limitation, any product such as but not limited to garments, including lingerie, panties, bras, shoes, medical bandages and dressing, decorations, clothing, carpets, pads, boxes or any other suitable curved objects.

The apparatus comprising a flocking machine (100), said flock machine comprising a curved mesh (101), the curved mesh conforming to a specific curved object (to be flocked) (10), so that every given zone on the curved object (10) is situated at a proximate similar distance (102) from a corresponding zone on the flocking machine mesh (101).

The flocking machine may comprise an optional curved brush, (103) wherein the flocked fibres (20) are transferred through the mesh (101), by the curved brush (103), which has a shape conforming to at least part of the mesh curved shape, the brush moves vibrate or rotates adjacent to the mesh (101), therefore pushing the fibers (20) through the mesh (101).

The mesh (101) may rotates or vibrate, relatively to the mesh, causing the fibres (20) to move through the mesh.

What is claimed:

1. An apparatus for flocking curved article, said apparatus comprising:
a flocking machine, said flocking machine comprising a curved mesh having a plurality of sectors; said curved mesh constructed to conform to a curved object to be flocked, wherein the curved object includes a plurality of sectors, and wherein the curved object is placed at a distance from the mesh such that a constant gap is provided between each sector on the curved object and the corresponding sector of the curved mesh.

2. The apparatus of claim 1 wherein the mesh is pre-made to match the curve of the object to be flocked before being installed onto the flocking machine.

3. The apparatus of claim 1 further comprising a brush, wherein said brush shape conforms, at least partially, to the shape of the flocking machine curved mesh.

4. The apparatus of claim 3 wherein said brush moves, vibrates, or rotates on top of or adjacent to the mesh, causing the fibers to move through the mesh.

5. The apparatus of claim 1, wherein the mesh itself rotates or vibrates, causing the fibres to move through said mesh.

6. The apparatus of claim 1 further comprising a pneumatic device utilizing pressurized air or gas to assist pushing the fibers towards the object to be flocked.

7. The apparatus according to claim 1 wherein the curved object is a part of or is placed on a conveying system.

8. The apparatus according to claim 1 wherein the curved mesh is a part of a moving carousel.

9. The apparatus according to claim 8 wherein the moving carousel comprises a plurality of curved meshes.
